(19) United States
(12) Patent Application Publication
(10) Pub. No.: US 2015/0131307 A1
(43) Pub. Date: May 14, 2015

(54) BACKLIGHT MODULE

(71) Applicant: Radiant Opto-Electronics Corporation, Kaohsiung (TW)

(72) Inventor: Tsai-Cheng HUANG, Kaohsiung (TW)

(73) Assignee: Radiant Opto-Electronics Corporation, Kaohsiung (TW)

(21) Appl. No.: 14/197,182

(22) Filed: Mar. 4, 2014

(30) Foreign Application Priority Data
Nov. 8, 2013 (TW) 102140777

(51) Int. Cl. F21V 8/00

(52) U.S. Cl. CPC G02B 6/0066; G02B 6/005
USPC 362/606; 362/611

(57) ABSTRACT

A backlight module is provided and includes a back plate, a light guide plate, a light source, a frame, at least one first positioning member and at least one second positioning member. The back plate includes at least one first limiting hole. The light guide plate is disposed on the back plate. The light source is disposed on the back plate and located at one side of the light guide plate. The frame is disposed on the back plate and includes at least one second limiting hole. The first positioning member is inserted into the first limiting hole and the second limiting hole along a first direction and includes a positioning portion. The second positioning member is inserted into the frame along a second direction and fixed in the positioning portion. The first direction is different from the second direction.

### RELATED APPLICATIONS

This application claims priority to Taiwan Application Serial Number 102140777, filed Nov. 8, 2013, which is herein incorporated by reference.

### BACKGROUND

1. Field of Invention

The present invention relates to a light source module. More particularly, the present invention relates to a backlight module.

2. Description of Related Art

Referring to FIG. 1 FIG. 1 is a schematic structural diagram of a conventional backlight module 100. The conventional backlight module 100 includes a back plate 110, a light guide plate 120, a frame 130, a light source 140 and a securing member 150. As shown in FIG. 1, the light guide plate 120 and the light source 140 are disposed on the back plate 110, in which the back plate 110 has a folding portion 110a, and the frame 130 has a folding portion 130a. The frame 130 can be secured on the back plate 110 by engaging the folding portion 130a with the folding portion 110a. In addition, the securing member 150 is inserted into the back plate 110 and the frame 130 to combine the back plate 110 with the frame 130.

However, the engagement of the folding portions 110a and 130a increases the overall thickness of the backlight module 100, and the frame 130 is likely to be peeled off from the back plate 110 due to collisions occurring during transportation of goods or other human factors, thus seriously affecting the structural stability of the backlight module 100. Furthermore, for achieving the engagement between the folding portions 110a and 130a, the folding portion 130a has to reserve a predetermined width A1 corresponding to the design of the folding portion 110a of the back plate 110, and such a structure is disadvantageous to the narrow frame design of the backlight module 100.

In addition, as shown in FIG. 1, because the back plate 110 has the folding portion 110a which is not suitable to combine the securing member 150, the opening 110b for mounting the securing member 150 has to be spaced at a distance from the folding portion 110a due to the limitation of the processing technique. Therefore, the structural designs of the folding portions 110a and 130a are disadvantageous to shrink the frame width of the backlight module 100.

### SUMMARY

One aspect of the present invention is to provide a backlight module, in which a first positioning member is used to confine a frame and a back plate, and a second positioning member is used to fasten the frame, the back plate and the first positioning member at the same time, thereby increasing joining strength between the frame and the back plate. Furthermore, the second positioning member is capable of directly fixing the back plate and the frame, and thus the overall thickness of the backlight module and the width of the frame can be decreased without the folding portions which can be engaged with each other on the frame and the back plate, thus meeting the trend of designing narrow frame backlight module.

According to the aforementioned objects, a backlight module is provided and includes a back plate, a light guide plate, a light source, a frame, at least one first positioning member and at least one second positioning member. The back plate includes at least one first limiting hole. The light guide plate is disposed on the back plate. The light source is disposed on the back plate and located at one side of the light guide plate. The frame is disposed on the back plate and includes at least one second limiting hole. The first positioning member is inserted into the first limiting hole and the second limiting hole along a first direction and includes a positioning portion. The second positioning member is inserted into the frame along a second direction and fixed in the positioning portion. The first direction is different from the second direction.

According to an embodiment of the present invention, the frame covers the back plate, and an accommodating space is formed between the frame and the back plate. The first positioning member is disposed in the accommodating space.

According to an embodiment of the present invention, the frame includes at least one third limiting hole corresponding to the positioning portion of the first positioning member, and the second positioning member is inserted into the third limiting hole and fixed in the positioning portion.

According to an embodiment of the present invention, the positioning portion is an opening penetrated through the first positioning member or a recess disposed on the first positioning member. The second positioning member is elongated, and two ends of the second positioning member are extended out of the third limiting hole respectively.

According to an embodiment of the present invention, the backlight module further includes at least one stopper which is disposed on the frame and abuts against an end face of the second positioning member to secure the second positioning member.

According to an embodiment of the present invention, the stopper is a cushioned material.

According to an embodiment of the present invention, the first positioning member is rivet-shaped, and the first positioning member includes an extended portion inserted into the second limiting hole.

According to an embodiment of the present invention, the backlight module further includes at least one optical film disposed on the light guide plate, in which the optical film includes an aperture disposed on the extended portion.

According to an embodiment of the present invention, the first positioning member includes an upper plate and a lower plate connected to the upper plate, and the positioning portion is a gap between the upper plate and the lower plate.

According to the aforementioned objects, a backlight module is provided and includes a back plate, a light guide plate, a light source, a frame, at least one first positioning member and at least one second positioning member. The back plate includes at least one first limiting hole. The light guide plate is disposed on the back plate. The light source emits light towards the light guide plate. The frame is associated with the back plate and includes at least one second limiting hole. The first positioning member is inserted into the first limiting hole and the second limiting hole along a first direction. The second positioning member is inserted into the frame along a second direction, in which the first direction is different from the second direction.

According to the aforementioned objects, a backlight module is provided and includes a back plate, a light guide plate, a light source, a frame, at least one first positioning member and at least one second positioning member. The light guide plate is disposed on the back plate. The light source emits light towards the light guide plate. The frame is associated with the back plate to define an accommodating space between the frame and the back plate. The first positioning member is disposed in the accommodating space to be engaged with both of the frame and the back plate along a first direction. The first positioning member comprises a positioning portion. The second positioning member is fixed in the positioning portion along a second direction, in which the first direction is different from the second direction.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic structural diagram of a conventional backlight module;

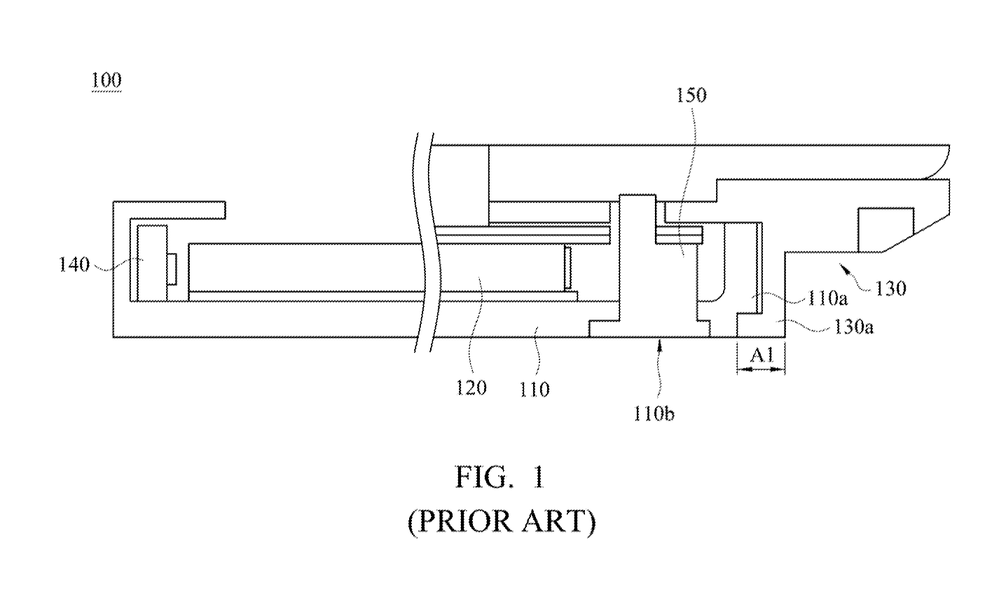

FIG. 2 is a schematic cross-sectional view of a backlight module in accordance with an embodiment of the present invention;

FIG. 3 is a schematic diagram showing a partial internal structural of a backlight module in accordance with an embodiment of the present invention;

FIG. 4 is a schematic partial 3D diagram of a backlight module in accordance with an embodiment of the present invention;

FIG. 5 is a schematic cross-sectional view of a backlight module in accordance with an embodiment of the present invention; and

FIG. 6A-FIG. 6C are schematic structural diagrams showing various first positioning members in accordance with embodiments of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

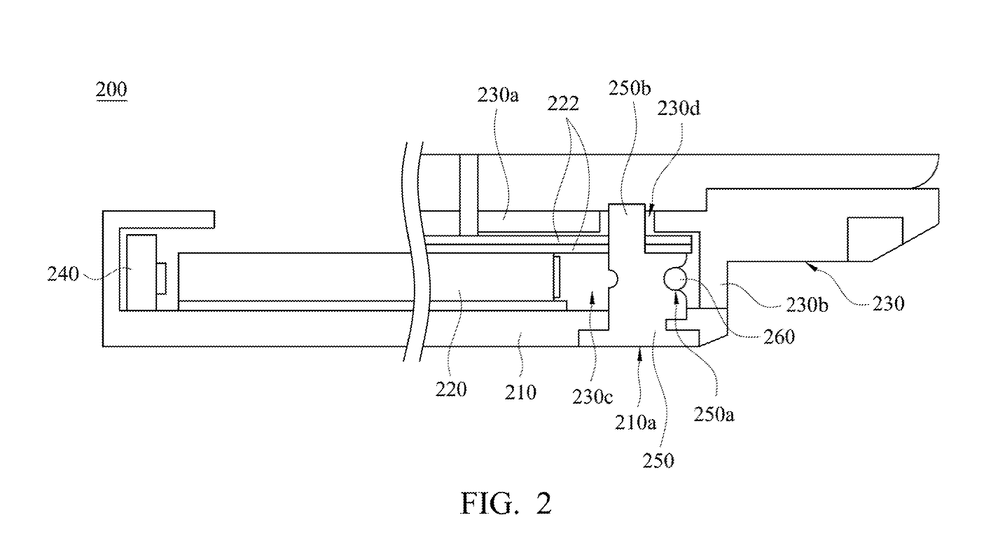

Referring to FIG. 2, FIG. 2 is a schematic cross-sectional view of a backlight module 200 in accordance with an embodiment of the present invention. The backlight module 200 includes a back plate 210, a light guide plate 220, a frame 230, a light source 240, at least one first positioning member 250 and at least one second positioning member 260. The light guide plate 220 and the light source 240 are disposed on the back plate 210, and the light source 240 is located at one side of the light guide plate 220 to emit light towards the light guide plate 220. The frame 230 is disposed on the back plate 210. The first positioning member 250 and the second positioning member 260 can be used to secure the frame 230 on the back plate 210, thus preventing the frame 230 from displacing relative to the back plate 210.

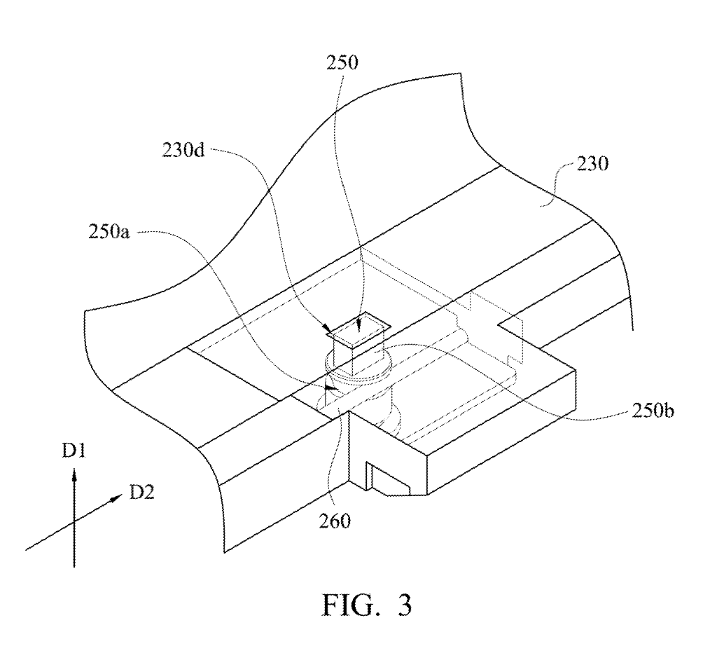

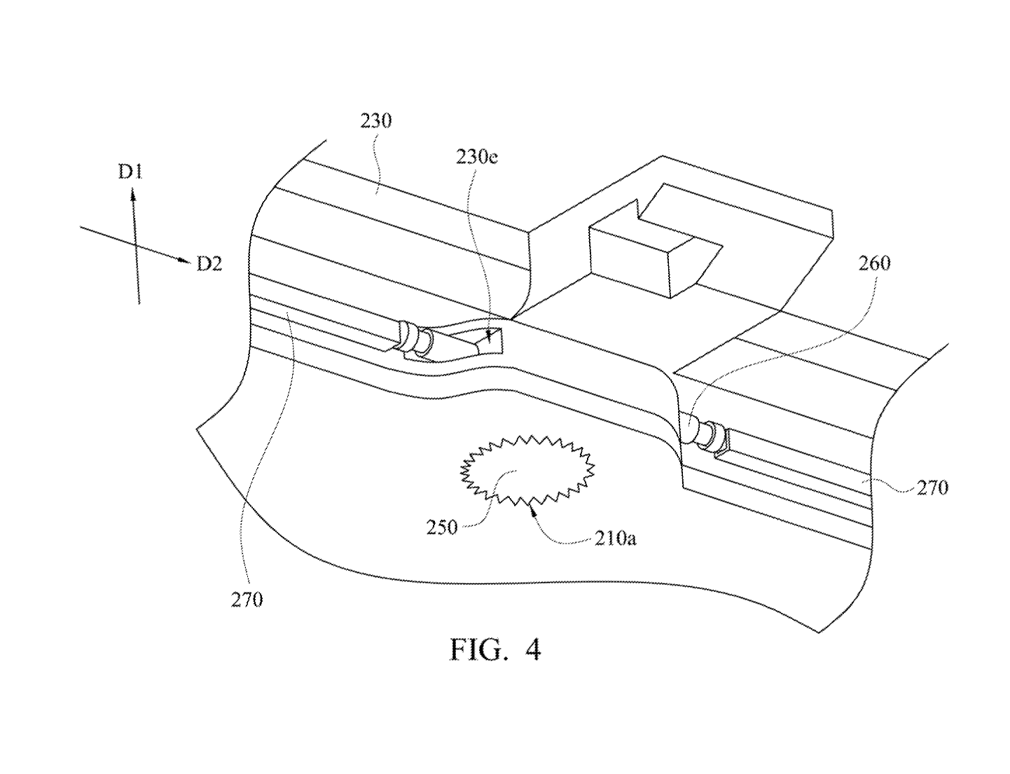

Referring to FIG. 2-FIG. 4, FIG. 3 is a schematic diagram showing a partial internal structural of the backlight module 200 in accordance with an embodiment of the present invention, and FIG. 4 is a schematic partial 3D diagram of the backlight module 200 in accordance with an embodiment of the present invention. The back plate 210 may be a flat plate and includes at least one first limiting hole 210a. As shown in FIG. 2, in one embodiment, the frame 230 has a side wall 230a and a side wall 230b connected to each other. In one example, a cross-sectional profile of the frame 230 is L-shaped in other words, in the frame 230, the side wall 230a is approximately parallel to the back plate 210, and the side wall 230b is approximately vertical to the back plate 210. Therefore, as the frame 230 covers over the back plate 210, an accommodating space 230c is defined among the side wall 230a, the side wall 230b and the back plate 210. As the light guide plate 220 is disposed on the back plate 210, a portion of the light guide plate 220 is located in the accommodating space 230c. Meanwhile, the side wall 230a can press against the light guide plate 220 for securing.

As shown in FIG. 2-FIG. 4, the frame 230 includes at least one second limiting hole 230d disposed on the side wall 230a. The first positioning member 250 is inserted into the first limiting hole 210a and the second limiting hole 230d along a first direction D1, and is disposed in the accommodating space 230c, in which the “first direction D1” stands for a direction vertical to the back plate 210, but is not limited thereto. Therefore, by inserting the first positioning member 250 into the first limiting hole 210a and the second limiting hole 230d, the frame 230 can be prevented from displacing along a direction which is parallel to the back plate 210.

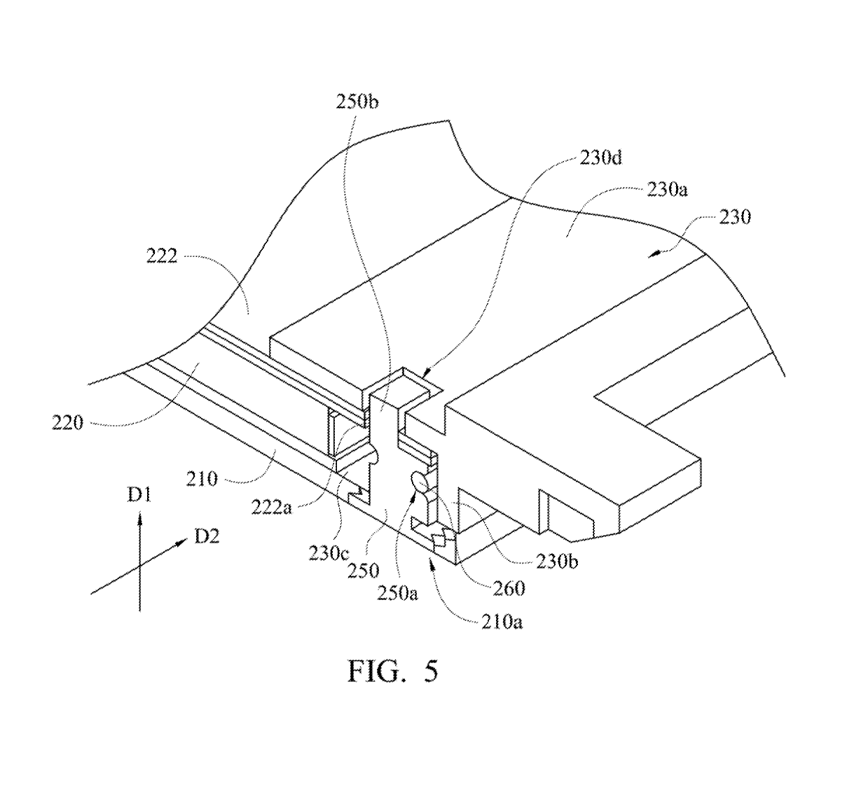

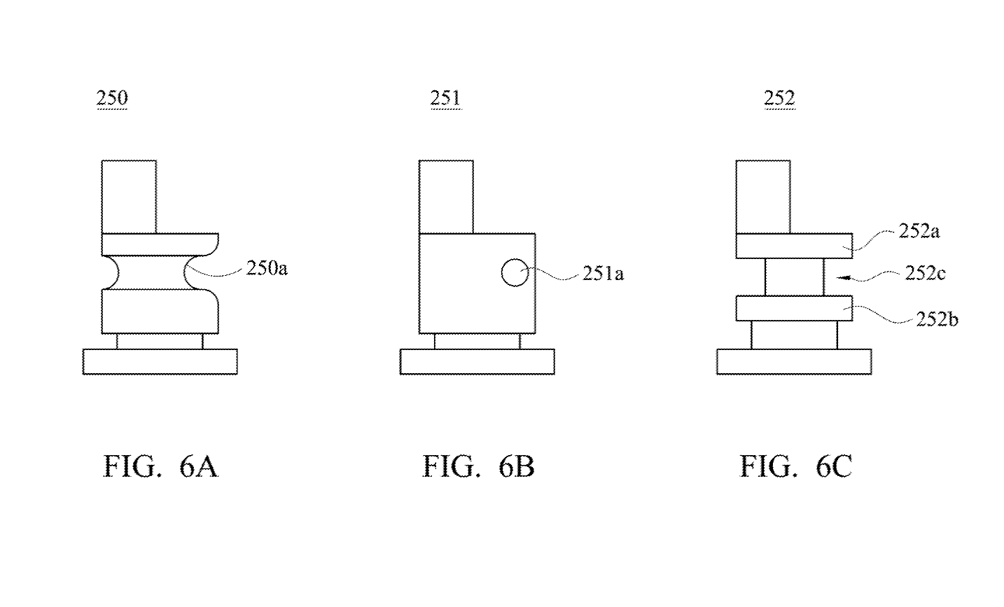

Also referring to FIG. 5, FIG. 5 is a schematic cross-sectional view of a backlight module in accordance with an embodiment of the present invention. The first positioning member 250 has a positioning portion 250a. The positioning portion 250a is extended along a second direction D2. Referring to FIG. 6A-FIG. 6C, FIG. 6A-FIG. 6C are schematic structural diagrams showing various first positioning members in accordance with embodiments of the present invention. As shown in FIG. 5 and FIG. 6A, the positioning portion 250a is a recess disposed on the first positioning member 250. For example, the positioning portion 250a is a recess disposed around a surface of the first positioning member 250. As shown in FIG. 6B, in one embodiment, a positioning portion 251a is an opening penetrating through a first positioning member 251. As shown in FIG. 6C, in one embodiment, a first positioning member 252 has an upper plate 252a and a lower plate 252b. The upper plate 252a is connected to the upper plate 252b, and a positioning portion 252c is a gap between the upper plate 252a and lower plate 252b. The positioning portions 250a, 251a and 252c are mainly used to secure the second positioning member 260. Hereinafter, the first positioning member 250 is used for explaining the embodiment of the present invention in detail.

Referring to FIG. 4, in one embodiment, the frame 230 has at least one third limiting hole 230e. The third limiting hole 230e is corresponding to the positioning portion 250a. Therefore, the second positioning member 260 is inserted into the third limiting hole 230e along the second direction D2 and fixed in the positioning portion 250a, in which the “second direction D2” stands for a direction parallel to the back plate 210, but is not limited thereto. Therefore, by inserting the second positioning member 260 horizontally into the third limiting hole 230e and the positioning portion 250a, the frame 230 can be prevented from escaping from the back plate 210. In one embodiment, the first direction D1 may be different to the second direction D2. In one example, the first direction D1 may be vertical to the second direction D2.

Referring to FIG. 3-FIG. 5, in one embodiment, the second positioning member 260 may be elongated. In one example, the second positioning member 260 may be a metal bar. Therefore, as the second positioning member 260 is disposed in the third limiting hole 230e, two ends of the second positioning member 260 are extended out of the frame 230 respectively. Meanwhile, the middle portion of the second positioning member 260 is fixed at the positioning portion 250a. As shown in FIG. 4, in one embodiment, the backlight module 200 further includes at least one stopper 270. The stopper 270 is disposed on the frame 230 and abuts against an end face of the second positioning member 260. The stopper 270 is mainly used to secure the second positioning member 260 to prevent the second positioning member 260 from escaping from the frame 230. In one example, the stopper 270 is a cushioned material. In other embodiments, the second positioning member 260 is a screwed member. Meanwhile, the second positioning member 260 and the positioning portion 250a are respectively implemented with corresponding threads, such that the second positioning member 260 may be directly inserted the third limiting hole 230e and screwed to the positioning portion 250a.

As shown in AG. 5, in one embodiment, the first positioning member 250 is rivet-shaped. Meanwhile, the first positioning member 250 has an extended portion 250b which can be inserted into the second limiting hole 230d so as to confine the frame 230. In other embodiments, the backlight module 200 further includes at least one optical film 222. The optical film 222 is disposed on the light guide plate 220, and the optical film 222 has an aperture 222a. Meanwhile, the optical film 222 can be disposed on the extended portion 250b through the aperture 222a. Therefore, the aperture 222a of the optical film 222 is corresponding to the extended portion 250b to achieve an object of limiting and securing the optical film 222.

A process for assembling the backlight module 200 is described below. In the assembling process, firstly, the light source 240 and the light guide plate 220 are disposed on the back plate 210, and the optical film 222 is disposed on the light guide plate 220. Thereafter, the frame 230 is disposed on the back plate 210, and the side wall 230a is attached to the light guide plate 220 and the optical film 222. Meanwhile, the first limiting hole 210a of the back plate 210 is opposite to the second limiting hole 230d of the frame 230. Then, the first positioning member 250 is inserted into the first limiting hole 210a, the aperture 222a of the optical film 222 and the second limiting hole 230d, so as to secure the back plate 210, the optical film 222 and the frame 230 along the first direction D1. Thereafter, the second positioning member 260 is inserted into the frame 230 and the third limiting hole 230e along the second direction D2, and is fastened in the positioning portion 250a, so as to secure the back plate 210 and the frame 230.

According to the aforementioned embodiments of the present invention, as the first positioning member is used to confine the frame and the back plate, and the second positioning member is used to fasten the frame, the back plate and the first positioning member at the same time, the joining strength between the frame and the back plate can be increased. Furthermore, the second positioning member is capable of directly fixing the back plate and the frame, and thus the overall thickness of the backlight module and the width of the frame can be decreased without the folding portions which can be engaged with each other on the frame and the back plate, thereby meeting the trend of designing, narrow frame backlight module.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A backlight module, comprising:
a back plate comprising at least one first limiting hole;
a light guide plate disposed on the back plate;
a light source which is disposed on the back plate and located at a side of the light guide plate;
a frame which is disposed on the back plate and comprises at least one second limiting hole,
at least one first positioning member which is inserted into the at least one first limiting hole and the at least one second limiting hole along a first direction and comprises a positioning portion; and
at least one second positioning member which is inserted into the frame along a second direction and fixed in the positioning portion, wherein the first direction is different from the second direction.

2. The backlight module of claim 1, wherein the frame covers the back plate and an accommodating space is formed between the frame and the back plate, and the at least one first positioning member is disposed in the accommodating space.

3. The backlight module of claim 1, wherein the frame comprises at least one third limiting hole corresponding to the positioning portion of the at least one first positioning member, and the at least one second positioning member is inserted into the at least one third limiting hole and fixed in the positioning portion.

4. The backlight module of claim 3, wherein the positioning portion is an opening penetrated through the at least one first positioning member or a recess disposed on the at least one first positioning member, wherein the at least one second positioning member is elongated, and two ends of the at least one second positioning member are extended out of the at least one third limiting hole respectively.

5. The backlight module of claim 4 further comprising at least one stopper which is disposed on the frame and abuts against an end face of the at least one second positioning member to secure the at least one second positioning member.

6. The backlight module of claim 5, wherein the stopper is cushioned material.

7. The backlight module of claim 1, wherein the at least one first positioning member is rivet-shaped, and the at least one first positioning member comprises an extended portion inserted into the at least one second limiting hole.

8. The backlight module of claim 7 further comprising at least one optical film disposed on the light guide plate, wherein the optical film comprises an aperture disposed on the extended portion.

9. The backlight module of claim 1, wherein the at least one first positioning member comprises an upper plate and a lower plate connected to the upper plate, and the at least one positioning portion is a gap between the upper plate and the lower plate.

10. A backlight module, comprising:
a back plate comprising at least one first limiting hole;
a light guide plate disposed on the back plate;
a light source emitting light towards the light guide plate;
a frame which is associated with the back plate and comprises at least one second limiting hole,
at least one first positioning member which is inserted into the at least one first limiting hole and the at least one second limiting hole along a first direction; and
at least one second positioning member which is inserted into the frame along a second direction, wherein the first direction is different from the second direction.

11. The backlight module of claim 10, wherein the frame covers the back plate and an accommodating space is formed between the frame and the back plate, and the at least one first positioning member is disposed in the accommodating space.

12. The backlight module of claim 10 further comprising at least one stopper which is disposed on the frame and abuts against an end face of the at least one second positioning member to secure the at least one second positioning member.

13. The backlight module of claim 10, wherein the at least one first positioning member is rivet-shaped, and the at least one first positioning member comprises an extended portion inserted into the at least one second limiting hole.

14. The backlight module of claim 13 further comprising at least one optical film disposed on the light guide plate, wherein the optical film comprises an aperture disposed on the extended portion.

15. A backlight module, comprising:
a back plate;
a light guide plate disposed on the back plate;
a light source emitting light towards the light guide plate;
a frame which is associated with the back plate to define an accommodating space between the frame and the back plate,
at least one first positioning member which is disposed in the accommodating space to be engaged with both of the frame and the back plate along a first direction and comprises a positioning portion; and
at least one second positioning member which is fixed in the positioning portion along a second direction, wherein the first direction is different from the second direction.

16. The backlight module of claim 15, wherein the frame comprises at least one third limiting hole corresponding to the positioning portion of the at least one first positioning member, and the at least one second positioning member is inserted into the at least one third limiting hole and fixed in the positioning portion.

17. The backlight module of claim 16, wherein the positioning portion is an opening penetrated through the at least one first positioning member or a recess disposed on the at least one first positioning member, wherein the at least one second positioning member is elongated, and two ends of the at least one second positioning member are extended out of the at least one third limiting hole respectively.

18. The backlight module of claim 17 further comprising at least one stopper which is disposed on the frame and abuts against an end face of the at least one second positioning member to secure the at least one second positioning member.

19. The backlight module of claim 15 further comprising at least one optical film disposed on the light guide plate, wherein the at least one first positioning member comprises an extended portion and the optical film comprises an aperture disposed on the extended portion.

20. The backlight module of claim 15, wherein the at least one first positioning member comprises an upper plate and a lower plate connected to the upper plate, and the positioning portion is a gap between the upper plate and the lower plate.
